(19) United States
(12) Patent Application Publication
(10) Pub. No.: US 2014/0146011 A1
(43) Pub. Date: May 29, 2014

(54) OLED TOUCH DISPLAY PANEL AND ELECTROMAGNETIC TYPE TOUCH DISPLAY DEVICE

(71) Applicant: HannStar Display Corporation, New Taipei City (TW)

(72) Inventors: CHIEN-HSIANG HUANG, Tainan City (TW); KUN-HUA TSAI, Tainan City (TW); JUN-SHIH CHUNG, Taichung City (TW); CHUN-HSI CHEN, Pingtung City (TW)

(73) Assignee: HannStar Display Corporation, New Taipei City (TW)

(21) Appl. No.: 14/091,890

(22) Filed: Nov. 27, 2013

(30) Foreign Application Priority Data
Nov. 28, 2012 (CN) 201210493299.X

(51) Int. Cl. G06F 3/041; G06F 3/044

(52) U.S. Cl. CPC G06F 3/0412; G06F 3/044
USPC 345/174

(57) ABSTRACT

An OLED touch display panel includes a substrate, a TFT circuit layer, an OLED element, a protective layer and an electromagnetic induction coil layer. The TFT circuit layer is formed above the substrate. The OLED element is formed on an upper surface of the TFT circuit layer. The protective layer is disposed above the OLED element, wherein both of the OLED element and the TFT circuit layer are located between the substrate and the protective layer. The electromagnetic induction coil layer is formed on an upper surface of the substrate or a lower surface of the protective layer. According to the OLED touch display panels in the first and second embodiments of the present invention, the electromagnetic induction coil layer is integrated to the original display panel, and thus the thickness and weight of the whole OLED touch display panel so as to decrease the cost.

### CROSS-REFERENCE TO RELATED APPLICATION

This application claims the benefit of China Patent Application No. 201210493299.X filed on Nov. 28, 2012, which is hereby incorporated by reference for all purposes as if fully set forth herein.

### BACKGROUND OF THE INVENTION

1. Field of Invention

This invention relates to an organic light emitting diode (OLED) touch display panel, and more particularly to an electromagnetic type OLED touch display panel and an electromagnetic type touch display device using the OLED touch display panel.

2. Related Art

A touch display device has been accepted by the people to become an interface tool for transmitting the information to each other. Recently, the sensing manner of the touch panel can be electromagnetic type, capacitance type or resistance type sensing manner. The electromagnetic type touch panel has an advantage of high pressing sense, and thus is greatly accepted in the market. The electromagnetic type touch module mainly includes a stylus and an electromagnetic type touch panel. The electromagnetic type touch panel includes an electromagnetic board circuit layer and a driving integrated circuit. The stylus has a signal sending end for sending an electromagnetic signal. The electromagnetic type touch panel has a receiving end for receiving and sensing the electromagnetic signal in an electromagnetic sensing manner. A magnetic flux is changed by the stylus, and then the electromagnetic type touch panel calculates the position of the stylus according to the changed magnetic flux.

Recently, an electromagnetic type touch display device generally includes an electromagnetic type touch module and a display panel. The electromagnetic type touch module and the display panel are manufactured independently. Then, the electromagnetic type touch panel of the electromagnetic type touch module is installed on the back of the display panel. But, the electromagnetic type touch module and the display panel are manufactured independently, and thus the cost and thickness of the whole electromagnetic type touch display device. Furthermore, the electromagnetic type touch display device uses the stylus to touch and control the display panel, and thus the accuracy is requested greatly. However, the electromagnetic type touch panel of the electromagnetic type touch module is installed on the back of the display panel in attaching manner, and thus the effect of touch control cannot be achieved certainly because of installation error.

Accordingly, there exists a need for a touch display panel and an electromagnetic type touch display device which includes an electromagnetic induction coil layer integrated to the original display panel so as to be capable of solving the above-mentioned problems.

### SUMMARY OF THE INVENTION

It is an objective of the present invention to provide an OLED touch display panel and an electromagnetic type touch display device which have small volume and low cost.

In order to achieve the objective, the present invention provides an OLED touch display panel including a substrate, a TFT circuit layer, an OLED element, a protective layer and an electromagnetic induction coil layer. The TFT circuit layer is formed above the substrate. The OLED element is formed on an upper surface of the TFT circuit layer. The protective layer is disposed above the OLED element, wherein both of the OLED element and the TFT circuit layer are located between the substrate and the protective layer. The electromagnetic induction coil layer is formed on one of an upper surface of the substrate and a lower surface of the protective layer.

The present invention further provides an electromagnetic type touch display device including an OLED touch display panel and an electromagnetic pointing unit. The OLED touch display panel includes a substrate, a TFT circuit layer, an OLED element, a protective layer and an electromagnetic induction coil layer. The TFT circuit layer is formed above the substrate. The OLED element is formed on an upper surface of the TFT circuit layer. The protective layer is disposed above the OLED element, wherein both of the OLED element and the TFT circuit layer are located between the substrate and the protective layer. The electromagnetic induction coil layer is formed on one of an upper surface of the substrate and a lower surface of the protective layer. The electromagnetic pointing unit is adapted to cause the electromagnetic induction coil layer of the OLED touch display panel to generate an electric signal.

According to the OLED touch display panels in the first and second embodiments of the present invention, the electromagnetic induction coil layer is integrated to the original display panel, and thus the thickness and weight of the whole OLED touch display panel so as to decrease the cost. Furthermore, when the electromagnetic induction coil layer is formed on the lower surface of the protective layer or the upper surface of the substrate, the electromagnetic induction coil layer can be certainly positioned on the lower surface of the protective layer or the upper surface of the substrate.

In order to make the aforementioned and other objectives, features and advantages of the present invention comprehensible, embodiments are described in detail below with reference to the accompanying drawings.

### BRIEF DESCRIPTION OF THE DRAWINGS

FIG. 1 is a schematic cross-sectional view of an organic light emitting diode (OLED) touch display panel according to the first embodiment of the present invention;

FIG. 2 is a schematic view showing structures of an electromagnetic induction coil layer, a driving integrated circuit and an electromagnetic pointing unit of the present invention;

FIG. 3 is a schematic cross-sectional view of an organic light emitting diode (OLED) touch display panel according to the second embodiment of the present invention; and

FIG. 4 is a schematic perspective view of an electromagnetic type touch display device according to an embodiment of the present invention.

The present invention will become more fully understood from the detailed description given herein below for illustration only, and thus are not limitative of the present invention, and wherein:

### DETAILED DESCRIPTION OF THE INVENTION

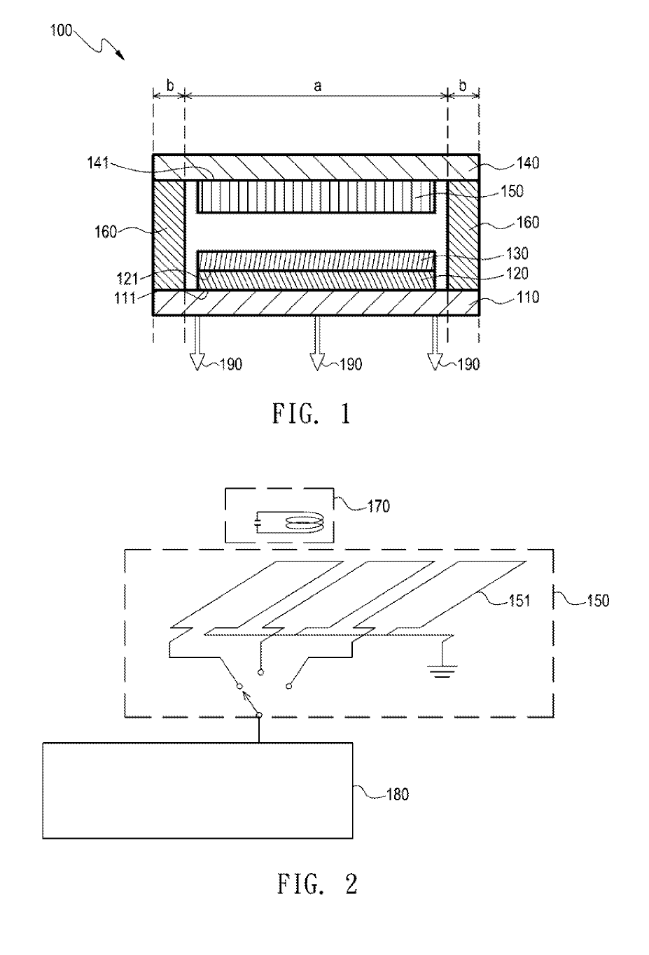

FIG. 1 is a schematic cross-sectional view of an organic light emitting diode (OLED) touch display panel according to the first embodiment of the present invention. As shown in FIG. 1, the OLED touch display panel 100 includes a substrate 110, a thin film transistor (TFT) circuit layer 120, an organic light emitting diode (OLED) element 130, a protective layer 140, an electromagnetic induction coil layer 150 and a sealing encapsulant 160.

The TFT circuit layer 120 is formed on an upper surface 111 of the substrate 110 by a lithography etching process, i.e., the TFT circuit layer 120 is formed above the substrate 110. The OLED element 130 is formed on an upper surface 121 of the TFT circuit layer 120, and is located between the protective layer 140 and the TFT circuit layer 120. The TFT circuit layer 120 generally includes a switch thin film transistor (TFT), a driving thin film transistor (TFT), a storage capacitor, a scan line and a data line.

The OLED element 130 is electrically connected to the TFT circuit layer 120, whereby the OLED element 130 generates different gray level according to signals of the TFT circuit layer 120. The OLED element 130 generally includes an anode layer, a cathode layer and an organic semiconductor layer. The organic semiconductor layer includes a red light emitting layer, a green light emitting layer and a blue light emitting layer, which all are disposed between the anode layer and the cathode layer. One of the above-mentioned anode layer and the cathode layer can be a transparent electrode, and the other one of the above-mentioned anode layer and the cathode layer can be one of metal layer, metal alloy layer, transparent metal oxide or a mix layers constituted by metal layer, metal alloy layer and transparent metal oxide. The substrate 110 can be transparent material selected from the group consisting of glass, polycarbonate (PC) and polyvinylchloride (PVC).

The gray level of the OLED element 130 depends on the voltage of the data line. When the scan line switches on the switch TFT, the voltage of the data line generates a necessary driving current which flows into the OLED element 130 through a gate of the driving TFT, and the OLED element 130 generates different gray level according to different inputted voltage. On the other hand, when the switch TFT is switched on, the storage capacitor is charged simultaneously so as to store the inputted voltage. When the switch TFT is switched off, the storage capacitor will keep the inputted voltage until the switch TFT is switched on next time, whereby the driving TFT is kept in a state of switch on, and the original brightness of the OLED element 130 can be kept.

The electromagnetic induction coil layer 150 is formed at a central region a of a lower surface 141 of the protective layer 140. As shown in FIG. 2, the electromagnetic induction coil layer 150 includes a plurality of sensor coils 151 constituted by conductors, and is electrically connected to a driving integrated circuit 180. An electromagnetic pointing unit 170 (e.g., a digital pen or a stylus) includes a resonance circuit for generating an electromagnetic signal. The sensor coils 151 are arranged in the horizontal or vertical directions, and are parallel to or partly overlapped with each other, whereby an electric signal generated by an electromagnetic field between the electromagnetic pointing unit 170 and the sensor coils 151 is detected, and then the driving integrated circuit 180 determines the position of the electromagnetic pointing unit 170 according to the electric signal.

Referring to FIG. 1 again, the protective layer 140 is disposed above the OLED element 130, wherein both of the OLED element 130 and the TFT circuit layer 120 are located between the substrate 110 and the protective layer 140. The protective layer 140 can be a hard substrate or a soft substrate. The hard substrate is made of material, e.g., polyethylene terephthalate (PET), polyethylene naphthalate (PEN), polyester (PES), polymethylmethacrylate (PMMA), polycarbonate (PC), polyimide (PI) or metal foil.

The sealing encapsulant 160 is formed on a peripheral region b of the upper surface 111 of the substrate 110 for bonding the peripheral region b of the upper surface 111 of the substrate 110 to a peripheral region b of the lower surface 141 of the protective layer 140. Also, the sealing encapsulant 160 is disposed around the OLED element 130, whereby the OLED element 130 is sealed between the substrate 110 and the protective layer 140.

The sealing encapsulant 160 provides a seal between the protective layer 140 and the substrate 110 for decreasing the invasion of mist and oxygen into the OLED element 130 and the electromagnetic induction coil layer 150 which both are located between the substrate 110 and the protective layer 140. In addition, the sealing encapsulant 160 can be made of light-sensitive material, e.g., light-sensitive material of ultraviolet light. The light-sensitive material is that: a material can be solidified by emitting a specific light to the material. However, in different technology, the sealing encapsulant 160 can be made of other materials, e.g., thermosetting material and expansible material, etc.

The above-mentioned OLED touch display panel 100 in the first embodiment is a

Bottom Emitting type touch display panel, i.e., the light of the OLED element 130 is emitted downward, and the emitting direction 190 of the OLED element 130 is shown in FIG. 1. Thus, the substrate 110 must be made of transparent material. But, it is not necessary that the protective layer 140 is made of transparent material. The electromagnetic induction coil layer 150 is not located in the emitting direction 190 of the OLED element 130, and thus the aperture ratio of the OLED touch display panel 100 cannot be decreased.

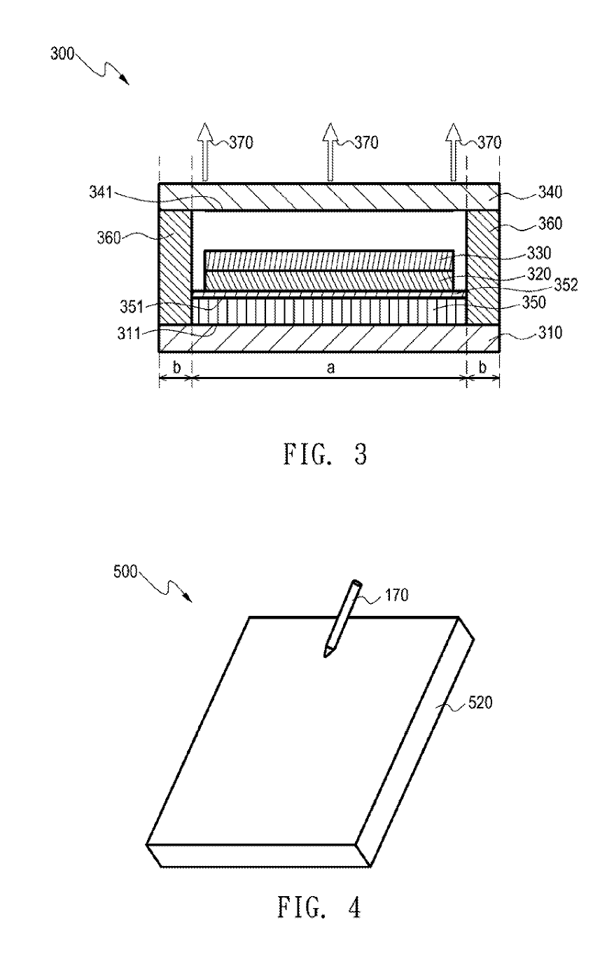

FIG. 3 is a schematic cross-sectional view of an organic light emitting diode (OLED) touch display panel according to the second embodiment of the present invention. The OLED touch display panel 300 in the second embodiment is substantially similar to the OLED touch display panel 100 in the first embodiment, wherein the similar elements are designated with the similar reference numerals. The difference between the OLED touch display panel 300 in the second embodiment and the OLED touch display panel 100 in the first embodiment is that: the formed position of electromagnetic induction coil layer.

More detailed, the difference between the OLED touch display panel 300 in the second embodiment and the OLED touch display panel 100 in the first embodiment is that: the electromagnetic induction coil layer 350 is formed at a central region a of an upper surface 331 of the substrate 310; an insulating layer 352 is formed on an upper surface 351 of the electromagnetic induction coil layer 350; the TFT circuit layer 320 is formed on the insulating layer 352, whereby the insulating layer 352 is located between the TFT circuit layer 320 and the electromagnetic induction coil layer 350; and the sealing encapsulant 360 is formed on a peripheral region b of the upper surface 311 of the substrate 310 for bonding the peripheral region b of the upper surface 311 of the substrate 310 to a peripheral region b of the lower surface 341 of the protective layer 340, and the sealing encapsulant 360 is disposed around the OLED element 330, whereby the OLED element 330 is sealed between the substrate 310 and the protective layer 340.

The above-mentioned OLED touch display panel 300 in the second embodiment is a Top Emitting type touch display panel, i.e., the light of the OLED element 330 is emitted upward, and the emitting direction 370 of the OLED element 330 is shown in FIG. 3. Thus, the protective layer 340 must be made of transparent material. But, it is not necessary that the substrate 310 is made of transparent material.

Referring to FIGS. 1 and 3 again, although the TFT circuit layer 120, 320 and the electromagnetic induction coil layer 150, 350 are sealed between the protective layer 140, 340 and the substrate 110, 310 by using the sealing encapsulant 160, 360, the TFT circuit layer 120, 320 and the electromagnetic induction coil layer 150, 350 can be still electrically connected to external elements located outside the OLED touch display panel 100, 300 through some conductive lines (not shown) in a conventional design.

According to the OLED touch display panels in the first and second embodiments of the present invention, the electromagnetic induction coil layer is integrated to the original display panel, and thus the thickness and weight of the whole OLED touch display panel so as to decrease the cost. Furthermore, when the electromagnetic induction coil layer is formed on the lower surface of the protective layer or the upper surface of the substrate, the electromagnetic induction coil layer can be certainly positioned on the lower surface of the protective layer or the upper surface of the substrate. After the protective layer is aligned with and attached to the sealing encapsulant, the electromagnetic induction coil layer located on the lower surface of the protective layer or the upper surface of the substrate can be certainly positioned. For example, during the attachment of the protective layer, a microscope is used to observe whether the protective layer is aligned with the sealing encapsulant or not, and the protective layer is not attached to the sealing encapsulant until the protective layer is aligned with the sealing encapsulant. Thus, the electromagnetic induction coil layer located on the lower surface of the protective layer can be certainly positioned.

As shown in FIG. 4, it depicts an electromagnetic type touch display device 500 according to an embodiment of the present invention. The electromagnetic type touch display device 500 includes an electromagnetic pointing unit 170 and an organic light emitting diode (OLED) touch display panel 520.

The electromagnetic pointing unit 170 can be adapted to cause the electromagnetic induction coil layer 150 of the OLED touch display panel 520 to generate an electric signal. For example, the electromagnetic pointing unit 170 can generate an electromagnetic signal. The OLED touch display panel 520 receives the electromagnetic signal, and then the electromagnetic induction coil layer 150 generates the electric signal according to the electromagnetic signal. The driving integrated circuit 180 determines the position of the electromagnetic pointing unit 170 according to the electric signal (as shown in FIG. 2 again).

The OLED touch display panel 520 can be the OLED touch display panels 100, 300 in the first and second embodiments, and thus there is no need to go into details.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An organic light emitting diode (OLED) touch display panel comprising:
a substrate;
a thin film transistor (TFT) circuit layer formed above the substrate;
an organic light emitting diode (OLED) element formed on an upper surface of the TFT circuit layer;
a protective layer disposed above the OLED element, wherein both of the OLED element and the TFT circuit layer are located between the substrate and the protective layer; and
an electromagnetic induction coil layer formed on one of an upper surface of the substrate and a lower surface of the protective layer.

2. The OLED touch display panel as claimed in claim 1, wherein the electromagnetic induction coil layer is formed at a central region of the lower surface of the protective layer; and the OLED touch display panel further comprises a sealing encapsulant for bonding a peripheral region of the upper surface of the substrate to a peripheral region of the lower surface of the protective layer, and the sealing encapsulant is disposed around the OLED element, whereby the OLED element is sealed between the substrate and the protective layer.

3. The OLED touch display panel as claimed in claim 2, wherein the substrate is made of transparent material.

4. The OLED touch display panel as claimed in claim 1, wherein the electromagnetic induction coil layer is formed at a central region of the upper surface of the substrate; and the OLED touch display panel further comprises a sealing encapsulant for bonding a peripheral region of the upper surface of the substrate to a peripheral region of the lower surface of the protective layer, and the sealing encapsulant is disposed around the OLED element, whereby the OLED element is sealed between the substrate and the protective layer.

5. The OLED touch display panel as claimed in claim 4, wherein the protective layer is made of transparent material.

6. The OLED touch display panel as claimed in claim 4, wherein the OLED touch display panel further comprises an insulating layer formed on an upper surface of the electromagnetic induction coil layer; and the TFT circuit layer is formed on the insulating layer, whereby the insulating layer is located between the TFT circuit layer and the electromagnetic induction coil layer.

7. An electromagnetic type touch display device comprising:
an organic light emitting diode (OLED) touch display panel as claimed in claim 1; and
an electromagnetic pointing unit adapted to cause the electromagnetic induction coil layer of the OLED touch display panel to generate an electric signal.

8. The electromagnetic type touch display device as claimed in claim 7, wherein the electromagnetic induction coil layer is formed at a central region of the lower surface of the protective layer; and the OLED touch display panel further comprises a sealing encapsulant for bonding a peripheral region of the upper surface of the substrate to a peripheral region of the lower surface of the protective layer, and the sealing encapsulant is disposed around the OLED element, whereby the OLED element is sealed between the substrate and the protective layer.

9. The electromagnetic type touch display device as claimed in claim 8, wherein the substrate is made of transparent material.

10. The electromagnetic type touch display device as claimed in claim 7, wherein the electromagnetic induction coil layer is formed at a central region of the upper surface of the substrate; and the OLED touch display panel further comprises a sealing encapsulant for bonding a peripheral region of the upper surface of the substrate to a peripheral region of the lower surface of the protective layer, and the sealing encapsulant is disposed around the OLED element, whereby the OLED element is sealed between the substrate and the protective layer.

11. The electromagnetic type touch display device as claimed in claim 10, wherein the protective layer is made of transparent material.

12. The electromagnetic type touch display device as claimed in claim 10, wherein the OLED touch display panel further comprises an insulating layer formed on an upper surface of the electromagnetic induction coil layer; and the TFT circuit layer is formed on the insulating layer, whereby the insulating layer is located between the TFT circuit layer and the electromagnetic induction coil layer.
